(19) United States
(12) Patent Application Publication
(10) Pub. No.: US 2013/0236791 A1
(43) Pub. Date: Sep. 12, 2013

(54) BATTERY AND METHOD FOR PRODUCING BATTERY (AS AMENDED)

(71) Applicants: Shingo Ogane, Toyota-shi (JP); Masakazu Umehara, Toyota-shi (JP)

(72) Inventors: Shingo Ogane, Toyota-shi (JP); Masakazu Umehara, Toyota-shi (JP)

(21) Appl. No.: 13/988,765

(22) PCT Filed: Nov. 24, 2010
(86) PCT No.: PCT/JP2010/070922

§ 371 Date: May 22, 2013

(51) Int. Cl. H01M 2/16; H01M 2/14

(52) U.S. Cl. CPC H01M 2/16; H01M 2/145
USPC 429/233; 427/58

(57) ABSTRACT

Disclosed is a method for producing a battery in which a separator layer having a high surface smoothness has been formed on a surface of at least one of the positive electrode and the negative electrode. This production method includes the steps of preparing a separator layer-forming coating having a viscosity of from 500 mPa·s to 5,000 mPa·s by mixing together at least insulating particles, a binder and a solvent; and applying the coating onto a surface of at least one of a positive electrode active material layer of a positive electrode and a negative electrode active material layer of a negative electrode.

### TECHNICAL FIELD

The present invention relates to a battery and a method for producing a battery.

### BACKGROUND ART

Electrode assemblies which include a positive electrode, a negative electrode and two separators situated between the positive electrode and the negative electrode have hitherto been commonly used in batteries. For example, the lithium ion batteries that have recently been attracting increased attention as a power source for driving electronic equipment and vehicles often use an electrode assembly obtained by stacking and winding together a positive electrode, a negative electrode and two separators, each of which is shaped in the form of a sheet. With this type of battery, the surface area per unit volume of the positive electrode and the negative electrode can be increased, enabling a higher energy density to be achieved.

Moreover, to increase battery performance such as “high-rate performance,” there exists a need for even further improvement in the efficiency of ionic conduction between the positive electrode and negative electrode. Increasing the ionic permeability of the separator is effective for enhancing the efficiency of ionic conduction. To this end, it is desirable for the separator to have a small thickness and a high surface smoothness.

Up until now, polyolefin-based resin films composed of polyethylene, polypropylene or the like have been commonly used as the separator. However, resin film separators must have a certain degree of mechanical strength so as not to tear during battery assembly. Hence, from the standpoint of strength retention, it would be difficult to make resin film separators thinner than they have been to date.

To address this challenge, it has been proposed that a layer which functions as a separator, i.e., a separator layer, be directly formed on the surface of the positive electrode or the negative electrode (see, for example, Patent Literature 1 and Patent Literature 2). Patent Literature 1 and Patent Literature 2 describe methods of forming a separator layer on the surface of a positive electrode or a negative electrode by preparing a coating that contains insulating particles (electrically insulating particles), a binder and a solvent, applying the coating onto the surface of the active material layer of a positive electrode or a negative electrode, then drying.

### CITATION LIST

### Patent Literature

Patent Literature 1: WO 97/08763
Patent Literature 2: Japanese Patent Application Laid-open No. 2000-149906

### SUMMARY OF INVENTION

### Technical Problem

The inventor has discovered that, when a separator layer is formed on the surface of a positive electrode or a negative electrode by a method such as that described above, large irregularities form in the surface of the separator layer and pinhole formation sometimes occurs. If the separator layer has a low surface smoothness, the distance between the positive electrode surface and the negative electrode surface (what is referred to as the “distance between electrodes”) will vary and variability may arise in the battery performance. Moreover, when the separator layer has a low surface smoothness, the electrically insulating properties of the separator layer may decrease.

Accordingly, one object of the invention is to provide a battery in which a separator layer has been formed on the surface of at least one of the positive electrode and the negative electrode, and the separator layer has a high surface smoothness. Another object of the invention is to provide a method for producing such a battery.

### Solution to Problem

The invention provides a method for producing a battery equipped with a positive electrode having a positive electrode active material layer, a negative electrode having a negative electrode active material layer, and a separator layer formed on a surface of at least one of the positive electrode active material layer and the negative electrode active material layer. The battery manufacturing method of the invention includes the steps of: providing a positive electrode which includes a positive electrode current collector and a positive electrode active material layer that contains a positive electrode active material and is formed on the positive electrode current conductor; providing a negative electrode which includes a negative electrode current collector and a negative electrode active material layer that contains a negative electrode active material and is formed on the negative electrode current conductor; preparing a separator layer-forming coating having a viscosity of from 500 mPa·s to 5,000 mPa·s by mixing together at least insulating particles, a hinder and a solvent; and forming a separator layer having electrically insulating properties and porosity by applying the coating to a surface of at least one of the positive electrode active material layer and the negative electrode active material layer, and drying the applied coating.

The inventor came to realize that one cause for the decrease in smoothness of the separator layer is as follows. That is, when a coating which includes insulating particles, a binder and a solvent is applied onto a surface of the active material layer of the positive electrode or the negative electrode, the solvent infiltrates into the active material layer, causing air to be forced from the active material layer. This air passes through the film of applied coating that ultimately forms the separator layer and, after reaching the surface of the film, is released to the exterior. The air is thought to form irregularities in the surface of the film at this time.

According to the production method of the invention, the separator layer-forming coating is prepared to a viscosity of at least 500 mPa·s. The coating has a relatively high viscosity, which suppresses solvent infiltration into the active material layer. Hence, the amount of air forced from the active material layer decreases, enabling the smoothness of the separator layer to be increased. However, if the coating viscosity is too high, the amount of the applied coating will have a tendency to vary. According to the production method of the invention, the coating viscosity is adjusted to not more than 5,000 mPa·s, which makes it possible to hold down the variability in the amount of the applied coating.

In one preferred aspect of the method for producing the battery disclosed herein, from 0.5 parts by weight to 65 parts by weight of a thickening agent per 100 parts by weight of the insulating particles is further added in the coating preparation step. In another preferred aspect of the method for producing the battery disclosed herein, the binder is included in the coating preparation step in an amount of not more than 3 parts by weight per 100 parts by weight of the insulating particles. In yet another preferred aspect of the method for producing the battery disclosed herein, in the coating preparation step, the binder is included in an amount of not more than 3 parts by weight per 100 parts by weight of the insulating particles, and from 0.5 parts by weight to 65 parts by weight of a thickening agent per 100 parts by weight of the insulating particles is further added, In this way, the viscosity of the coating is easily adjusted within the desired range.

According to the present invention, there is also provided a battery having a positive electrode, a negative electrode and a separator layer. The positive electrode includes a positive electrode current collector and a positive electrode active material layer that contains a positive electrode active material and is formed on the positive electrode current conductor. The negative electrode includes a negative electrode current collector and a negative electrode active material layer that contains a negative electrode active material and is formed on the negative electrode current conductor. The separator layer includes insulating particles, a binder and a thickening agent. The separator layer has electrically insulating properties and porosity, and is formed on a surface of at least one of the positive electrode active material layer and the negative electrode active material layer. The binder has a mass ratio of not more than 2% with respect to the separator layer. The thickening agent has a mass ratio of from 0.2% to 22.6% with respect to the separator layer. In this way, there can be obtained a battery having a separator layer formed on a surface of at least one of the positive electrode and the negative electrode, the separator layer having a high surface smoothness.

In a preferred aspect of the battery disclosed herein, the insulating particles have an average particle size of at least 3 μm and the separator layer has a porosity of at least 35%. A separator layer having an ionic permeability comparable with that in conventional batteries can thus be obtained.

### BRIEF DESCRIPTION OF DRAWINGS

FIG. 1 is a sectional view showing the electrode assembly in a battery according to one embodiment of the invention.

FIG. 2 is a sectional view showing the electrode assembly in a battery according to another embodiment of the invention.

FIG. 3 is a sectional view showing the electrode assembly in a battery according to yet another embodiment of the invention.

FIG. 4 is a perspective view showing the internal structure of a battery according to one embodiment of the invention.

FIG. 5 is a side view showing a vehicle (automobile) equipped with a battery according to one embodiment of the invention.

FIG. 6 is a graph showing the relationship between the binder weight ratio and the coating viscosity.

FIG. 7 is a graph showing the relationship between the thickening agent weight ratio and the coating viscosity.

FIG. 8 is a graph showing the relationship between the thickening agent weight ratio and the coating viscosity.

FIG. 9 is a sectional view showing the structure of a sample used in an experiment to measure the air permeability of a separator layer.

FIG. 10 is a graph showing the relationship between the average particle size of the insulating particles and the porosity of the separator layer.

### DESCRIPTION OF EMBODIMENTS

Preferred embodiments of the invention are described below. Matters not specifically mentioned in the Description but necessary for carrying out the invention will be understood as matters of design by persons of ordinary skill in the art which are based on prior art in the field. The present invention can be carried out based on details disclosed in the Description and on common general technical knowledge in the field.

The art disclosed herein can be applied broadly to batteries having a positive electrode which includes a positive electrode current collector and a positive electrode active material layer formed on the positive electrode current conductor, a negative electrode which includes a negative electrode current collector and a negative electrode active material layer formed on the negative electrode current conductor, and a separator layer endowed with electrically insulating properties and porosity which is formed on the surface of at least one of the positive electrode active material layer and the negative electrode active material layer and is situated between the positive electrode active material layer and the negative electrode active material layer. The battery disclosed herein may be a primary battery, or may be a secondary battery. The present invention is described below in greater detail with reference to, by way of illustration, primarily lithium ion secondary batteries, although it is not the intention here to limit the application of this invention only to such batteries.

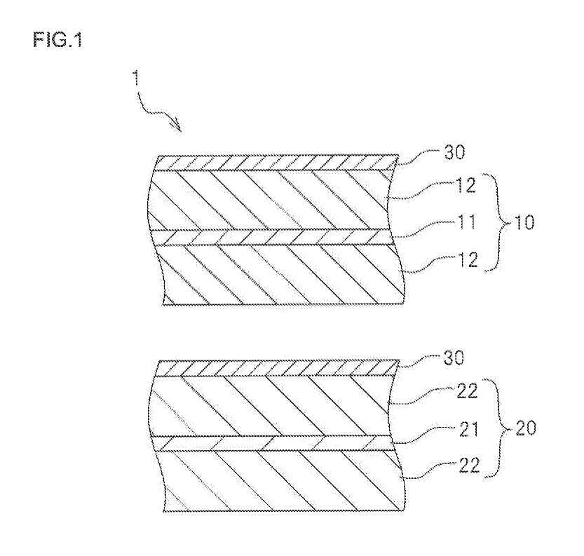

Referring to FIG. 1, the lithium ion secondary battery according to the present embodiment is equipped with an electrode assembly 1 having a positive electrode 10 and a negative electrode 20. The positive electrode 10 has a sheet-shaped positive electrode current collector 11 and positive electrode active material layers 12 that contain a positive electrode active material and are formed on the positive electrode current collector 11. The negative electrode 20 has a sheet-shaped negative electrode current collector 21 and negative electrode active material layers 22 that contain a negative electrode active material and are formed on the negative electrode current collector 21. The positive electrode 10 and the negative electrode 20 are not limited in shape to sheets, and may instead have a rod-like or other suitable shape.

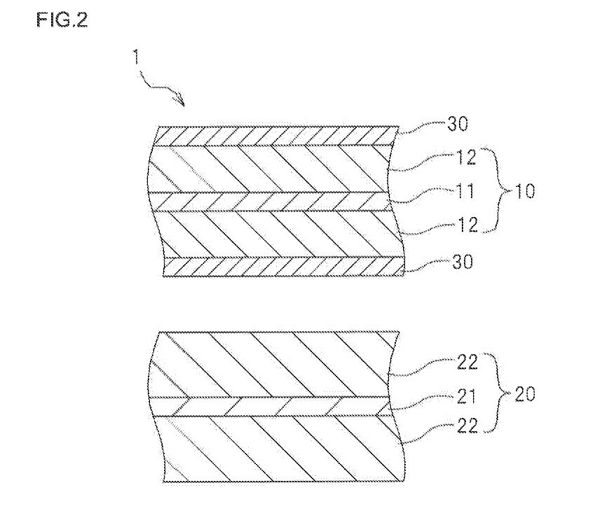

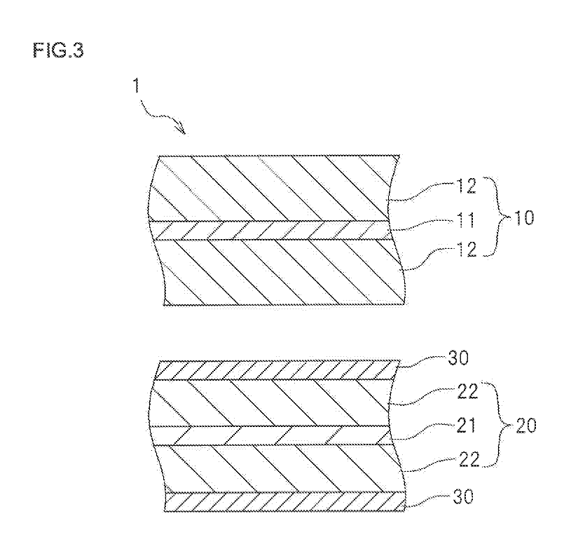

A separator layer 30 having electrical insulating properties and porosity is formed on the surface of the positive electrode active material layer 12. In FIG. 1, the positive electrode 10 and the negative electrode 20 are shown separated, although the positive electrode 10 and the negative electrode 20 are actually stacked one over the other. The separator layer 30 is situated between the positive electrode 10 and the negative electrode 20 and, more precisely, between the positive electrode active material layer 12 and the negative electrode active material layer 22. Ion-conducting paths between the positive electrode 10 and the negative electrode 20 are formed by pores within the separator layer 30. So long as the separator layer 30 is situated between the positive electrode 10 and the negative electrode 20, there is no particular limitation in the manner in which the separator layer 30 is arranged. As shown in FIG. 1, separator layers 30 may be formed on one side of the positive electrode 10 and on one side of the negative electrode 20. Alternatively, as shown in FIG. 2, separator layers 30 may be formed on both sides of the positive electrode 10. In this case, because a separator layer 30 is situated between the positive electrode 10 and the negative electrode 20, it is not always necessary to provide a separator layer 30 at the surface of the negative electrode 20. As shown in FIG. 3, separator layers 30 may be formed on both sides of the negative electrode 20. In this case, it is not always necessary to provide a separator layer 30 at the surface of the positive electrode 10. It is also possible to form respective separator layers 30 on the surface of the positive electrode 10 and on the surface of the negative electrode 20, and to arrange these separator layers as successive layers.

FIG. 1 and the other appended diagrams show only one positive electrode 10 and one negative electrode 20, although a plurality of positive electrodes 10 and a plurality of negative electrodes 20 may be stacked together in an alternating manner. Or the positive electrode 10 and the negative electrode 20 may be arranged as successive layers and wound together.

First, the separator layer 30 is explained. The separator layer 30 has electrical insulating properties and porosity. In addition, the separator layer 30 has thermoplasticity and thus melts at and above a given temperature, obstructing the pores at the interior. That is, the separator layer 30 has what is referred to as a “shutdown function.”

The separator layer 30 is formed by applying a separator layer-forming composition (referred to below as a “coating”) onto the surface of a positive electrode active material layer 12 or the surface of a negative electrode active material layer 22, and drying the coating. The coating viscosity is preferably from 500 mPa·s to 5,000 mPa·s. The coating viscosity in this Description refers to the viscosity measured with a Brookfield viscometer (Brookfield type viscometer) at a spindle speed of 60 rpm. The coating contains insulating particles (electrically insulating particles), a binder that bonds together the insulating particles, and a solvent that disperses the insulating particles and the binder. The coating additionally contains, where suitable, a thickening agent. The separator layer 30 formed by drying the coating includes insulating particles and a binder, and further includes, where suitable, a thickening agent.

The thickness of the separator layer 30, although not particularly limited, is preferably, for example, from 1 μm to 100 μm, and more preferably from 10 μm to 50 μm. If the separator layer 30 has a small thickness, the electrical insulating properties between the positive electrode 10 and the negative electrode 20 will tend to decrease. On the other hand, if the thickness of the separator layer 30 is too large, the separator layer 30 accounts for a larger proportion of the electrode assembly 1, which tends to cause a decline in battery capacity.

The porosity of the separator layer 30 is not particularly limited, although a porosity of at least 35% is preferred in order to retain an ionic permeability equal to or higher than that of conventional separators composed of polyethylene film or the like. The porosity of the separator layer 30 may be calculated as follows. Letting V1 (cm³) be the apparent volume occupied by a separator layer 30 having a surface area expressed in terms of unit area and V0 be the ratio W/ρ of the mass W (g) of the separator layer 30 to the density (solids density) ρ (g/cm³) of the material making up the separator layer 30, and moreover taking V0 to be the volume occupied by a dense body of the separator layer-forming material of mass W, the porosity of the separator layer 30 can be calculated as (V1−V0)/V1×100.

Particles of various materials that have hitherto been used in the art may be used as the insulating particles. The insulating particles may be particles of an inorganic substance or may be particles of an organic substance. Examples of inorganic substances that may be used include oxides such as iron oxide, silicon oxide, aluminum oxide and titanium oxide, nitrides such as aluminum nitride and boron nitride, covalently bonded crystal particles such as silicon and diamond, and poorly soluble ionically bonded particles such as barium sulfate, calcium fluoride and barium fluoride. Examples of organic substances include polyethylene, polypropylene, polystyrene, polyvinyl chloride, polyvinylidene chloride, polyacrylonitrile, polymethyl methacrylate, polyacrylate, fluoroplastics (e.g., polytetrafluoroethylene, polyvinylene fluoride), polyamide resins, polyimide resins, polyester resins, polycarbonate resins, polyphenylene oxide resins, silicone resins, phenolic resins, urea resins, melamine resins, polyurethane resins, polyether resins (e.g., polyethylene oxide, polypropylene oxide), epoxy resins, acetal resins, AS resins and ABS resins.

The insulating particles have an average particle size which is, for example, preferably from 0.1 μm to 10 μm, and more preferably from 1 μm to 6 μm. When the porosity of the separator layer 30 is set to at least 35%, it is preferable for the average particle size of the insulating particles to be at least 3 μm. The particles are not limited to spherical shapes, and may have other shapes, such as needle-like, rod-like, spindle-like or tabular shapes.

A variety of materials hitherto used in the art may be used as the binder, including various types of polymers, ionomer resins and the like. Examples of binders that may be used include latexes (e.g., styrene-butadiene copolymer latex, acrylonitrile-butadiene copolymer latex), cellulose derivatives (e.g., sodium salts of carboxymethyl cellulose), fluororubbers (e.g., copolymers of vinylidene fluoride, hexafluoropropylene and tetrafluoroethylene), and fluororesins (e.g., polyvinylidene fluoride, polytetrafluoroethylene).

The amount of binder included in the coating is not subject to any particular limitation, although the amount of binder may be set to 3 parts by weight or less per 100 parts by weight of the insulating particles. This makes it easy to adjust the viscosity of the coating within the above-described range.

As described above, a thickening agent (a thickener) may be added to the coating in order to adjust the coating viscosity. The thickening agent material is not particularly limited. Preferred use can be made of various types of thickening agents which exist stably within the battery and do not hinder the inherent function of the separator layer 30. For example, use can be made of sodium polyacrylate, ammonium polyacrylate or the like as the thickening agent.

The amount of thickening agent added may be suitably adjusted to give a coating viscosity of from 500 mPa·s to 5,000 mPa·s. For example, the amount of thickening agent added may be set to from 0.5 parts by weight to 65 parts by weight per 100 parts by weight of the insulating particles. This makes it easy to adjust the coating viscosity within the above-indicated range.

Next, the positive electrode 10 is explained. Any of various types of positive electrodes hitherto used as positive electrodes for lithium ion secondary batteries may be used as the positive electrode 10. A member composed primarily of a metal having good electrical conductivity, such as copper, nickel, aluminum, titanium or stainless steel, may be used as the positive electrode current collector 11. Preferred use may be made of for example, aluminum or alloys composed primarily of aluminum (aluminum alloys) as the positive electrode current collector 11 for a lithium ion secondary battery. Other examples include amphoteric metals such as zinc and tin, and alloys composed primarily of one of these metals. The shape of the positive electrode current collector 11 is not particularly limited, although use is made of a sheet-shaped aluminum positive electrode current collector 11 in the present embodiment. For example, preferred use may be made of an aluminum sheet having a thickness of from about 10 μm to about 30 μm.

A material which is capable of intercalating (storing) and deintercalating (releasing) lithium may be used as the positive electrode active material in the positive electrode active material layer 12. One or two or more substances hitherto used in lithium ion secondary batteries (e.g., oxides having a layer structure, and oxides having a spinel structure) may be used without particular limitation. Illustrative examples include lithium-containing complex oxides such as lithium nickel complex oxides, lithium cobalt complex oxides, lithium-manganese complex oxides and lithium-magnesium complex oxides.

As used herein, “lithium-nickel complex oxide” encompasses oxides in which the constituent metal elements are lithium (Li) and nickel (Ni), and also oxides which contain as the constituent metal elements not only lithium and nickel, but also at least one other metal element (i.e., a transition metal element and/or typical metal element other than Li and Ni) in a ratio (based on the number of atoms) that is about the same as nickel or smaller than nickel (typically a ratio that is smaller than nickel). The metal element other than Li and Ni may be, for example, one or two or more metal elements selected from the group consisting of cobalt (Co), aluminum (Al), manganese (Mn), chromium (Cr), iron (Fe), vanadium (V), magnesium (Mg), titanium (Ti), zirconium (Zr), niobium (Nb), molybdenum (Mo), tungsten (W), copper (Cu), zinc (Zn), gallium (Ga), indium (In), tin (Sn), lanthanum (La) and cerium (Ce). The terms “lithium-cobalt complex oxide,” “lithium-manganese complex oxide” and “lithium-magnesium complex oxide” have similar meanings.

Alternatively, olivine-type lithium phosphates having the general formula LiMPO₄ (wherein M is one or more element from among Co, Ni, Mn and Fe; e.g., LiFeO₄, LiMnPO₄) may be used as the positive electrode active material.

Other examples of positive electrode active materials that may be used in the art disclosed herein include so-called polyanionic positive electrode active materials such as lithium iron phosphate, lithium nickel phosphate, lithium cobalt phosphate, lithium manganese phosphate and lithium iron silicate.

In addition to a positive electrode active material, the positive electrode active material layer 12 may optionally include also, for example, a conductive material and a binder. As with the conductive materials in the electrodes of conventional lithium ion secondary batteries, preferred use may be made of a carbon material such as carbon black (e.g., acetylene black) or graphite powder as the conductive material. Examples of binders that may be used include polyvinylidene fluoride (PVDF), carboxymethyl cellulose (CMC) and styrene butadiene rubber (SBR). Although not particularly limited, the amount of conductive material used per 100 parts by weight of the positive electrode active material may be set to, for example, from 1 part by weight to 20 parts by weight. The amount of binder used per 100 parts by weight of the positive electrode active material may be set to, for example, from 0.5 parts by weight to 10 parts by weight.

The positive electrode active material layer 12 may be produced in the following way, for example. First, a composition (typically a paste or slurry-like composition) in the form of a positive electrode active material and a conductive material dispersed in a liquid medium containing a suitable solvent and a binder is prepared. The composition is then applied onto the positive electrode current collector 11, dried and, if desired, pressed. It is possible in this way to obtain the positive electrode active material layer 12. Any of the following may be used as the solvent: water, an organic solvent, or a mixed solvent thereof.

Next, the negative electrode 20 is explained. Any of various types of negative electrodes hitherto used as negative electrodes for lithium ion secondary batteries may be used as the negative electrode 20. A conductive member composed of a metal having good electrical conductivity may be preferably used as the negative electrode current collector 21. For example, use may be made of copper or an alloy composed primarily of copper. The shape of the negative electrode current collector 21 is not particularly limited, although a sheet-shaped negative electrode current collector 21 made of copper is used in the present embodiment. For example, preferred use may be made of a copper sheet having a thickness of from about 5 μm to about 30 μm.

One or two or more types of materials that have hitherto been used in lithium ion secondary batteries may be used without particular limitation as the negative electrode active material. An example of a preferred negative, electrode active material is carbon particles, Preferred use may be made of a granular carbon material (carbon particles) which includes in at least some portion thereof a graphite structure (layer structure). Any carbon materials from among graphitic materials (graphite), carbon materials that are difficult to graphitize (hard carbon), carbon materials that are easy to graphitize (soft carbon), and materials having structures in which these are combined may be suitably used.

In addition to the negative electrode active material, the negative electrode active material layer 22 may include, for example, a conductive material, a binder and the like similar to those used in the positive electrode active material layer 12. Although not particularly limited, the amount of binder used per 100 parts by weight of the negative electrode active material may be set to, for example, from 0.5 to 10 parts by weight. As with the positive electrode active material layer 12, the negative electrode active material layer 22 may be advantageously produced by preparing a composition in the form of the negative electrode active material dispersed in a liquid medium containing a suitable solvent and a binder, then applying the composition onto the negative electrode current collector 21, drying the applied composition and, where desired, pressing the dried composition.

As described above, the separator layers 30 are formed by applying a separator layer-forming coating onto the surfaces of the positive electrode active material layer 12 and the negative electrode active material layer 22, then drying the applied coating. Next, an example of a method of forming the separator layer 30 is described.

First, a separator layer-forming coating is prepared by mixing together insulating particles, a binder and a solvent, and optionally adding a thickening agent. The viscosity of the coating is adjusted at this time to from 500 mPa·s to 5,000 mPa·s.

The coating is then applied onto the surfaces of the positive electrode active material layer 12 and the negative electrode active material layer 22. No particular limitation is imposed on the method of applying the above coating; use may be made of any method known to the art. The coating may be applied using, for example, a die coater, a gravure roll coater a reverse roll water, a kiss roll coaxer, a dip roll coater, a bar coater, an air knife coater, a spray coater, a brush coater or a screen coater.

The coating is then dried. Any method known to the art may be used to dry the applied coating. For example, use may be made of a method in which the coating is left to stand for a given length of time at a given temperature, or a method that involves blowing hot air over the coating. As a result, separator layers 30 form on the surfaces of the positive electrode 10 and the negative electrode 20.

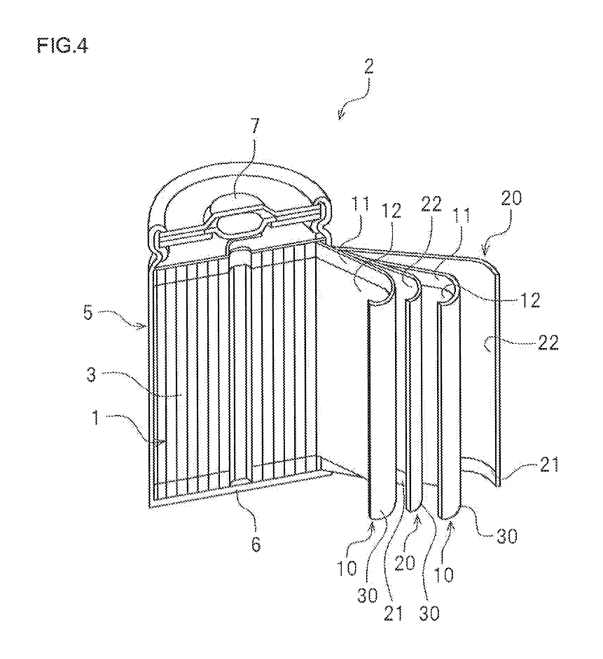

FIG. 4 shows an example of a lithium ion secondary battery 2 that includes an electrode assembly 1. The lithium ion secondary battery 2 has a construction in which the electrode assembly 1 is housed together with a nonaqueous electrolyte 3 within a battery case 5. At least part of the nonaqueous electrolyte 3 is impregnated into the electrode assembly 1.

The positive electrodes 10 and the negative electrodes 20 having separator layers 30 formed on the surfaces thereof are formed into continuous sheets. The positive electrodes 10 and the negative electrodes 20 are stacked together with separator layers 30 situated between a positive electrode 10 and a negative electrode 20, and are wound into a cylindrical shape.

The battery case 5 includes a cylindrical case body 6 which is closed at one end and a cover 7 which closes the open end thereof. The cover 7 and the case body 6 are each made of metal, and are mutually insulated. The cover 7 is electrically connected to the positive electrode current collector 11, and the case body 6 is electrically connected to the negative electrode current collector 21. In this lithium ion secondary battery 2, the cover 7 also serves as the positive electrode terminal and the case body 6 also serves as the negative electrode terminal.

On one side of the positive electrodes 10, at one edge along the lengthwise direction of the positive electrode current collectors 11 (the top side in FIG. 4), there is provided a portion where positive electrode active material layer 12 has not been provided and the positive electrode current collector 11 is exposed. The cover 7 is electrically connected to this exposed portion. On one side of the negative electrodes 20, at one edge along the lengthwise direction of the negative electrode current collector 21 (the bottom side in FIG. 4), there is provided a portion where the negative electrode active material layer 22 has not been provided and the negative electrode current collector 21 is exposed. The case body 6 is electrically connected to this exposed portion.

The nonaqueous electrolyte 3 contains a lithium salt as the supporting salt within an organic solvent (nonaqueous solvent). A known lithium salt that has hitherto been used as a supporting salt in nonaqueous electrolytes for lithium ion secondary batteries may be suitably selected and used as the lithium salt. Illustrative examples of such lithium salts include LiPF₆, LiBF₄, LiClO₄, LiAsF₆, Li(CF₃SO₂)₂N and LiCF₃SO₃. An organic solvent which is used in conventional lithium ion secondary batteries may be suitably selected and used as the nonaqueous solvent. Especially preferred nonaqueous solvents include ethylene carbonate (EC), dimethyl carbonate (DMC), ethyl methyl carbonate (EMC), diethyl carbonate (DEC) and propylene carbonate (PC).

A lithium ion secondary battery 2 is manufactured as follows, for example. First, the positive electrodes 10 and the negative electrodes 20 are produced. Next, separator layers 30 are formed on the surfaces of the positive electrode active material layer 12 and the negative electrode active material layer 22 by the method described above. The positive electrodes 10 on which a separator layer 30 has been formed and the negative electrodes 20 on which a separator layer 30 has been formed are stacked together and wound into a cylindrical shape, thereby creating a electrode assembly 1. A nonaqueous electrolyte 3 is then impregnated into the electrode assembly 1, and the electrode assembly 1 is placed within a battery case 5. A cover 7 is joined to the battery case 5, thereby hermetically sealing the electrode assembly 1 and the nonaqueous electrolyte 3.

The lithium ion secondary battery 2 according to this embodiment may be used as a secondary battery for various applications. For example, as shown in FIG. 5, it may be advantageously used as a power supply for a vehicle-driving motor (electrical motor) that is mounted in a vehicle 9 such as an automobile. The type of vehicle 9 is not particularly limited, but is typically, for example, a hybrid automobile, an electric automobile or a fuel cell automobile. This lithium ion secondary battery 2 may be used alone, or may be used in the form of a battery pack in which a plurality of lithium ion secondary batteries 2 are connected in serial and/or in parallel.

The inventor found that when a separator layer is formed on the surface of a positive electrode or a negative electrode (collectively referred to below as simply the “electrode”), one reason why the surface smoothness of the separator layer decreases is as follows. When the coating is applied onto a surface of the active material layer of an electrode, the solvent within the coating infiltrates into the active material layer, causing air to be forced from the active material layer. After drying has taken place, this air passes through the film of applied coating that ultimately forms the separator layer and, after reaching the surface of the film, is released to the exterior. The air forms pinholes or irregularities on the surface of the film at this time, lowering the smoothness of the separator layer.

The inventor also found that, by adjusting the viscosity of the coating, solvent infiltration into the active material layer could be suppressed, making it possible in turn to suppress the decline in the smoothness of the separator layer. Using a plurality of coatings of differing viscosities, the inventor formed separator layers having a thickness of 32 μm, and used a laser microscope to examine the surfaces of the separator layers for pinholes. As a result, it was found that about 6 pinholes per 10 mm² form when the coating viscosity is less than 500 mPa·s, but no pinholes form when the viscosity is 500 mPa·s or more. As used herein, “pinhole” refers to a pore-like flaw that extends from the surface of the separator layer to the electrode.

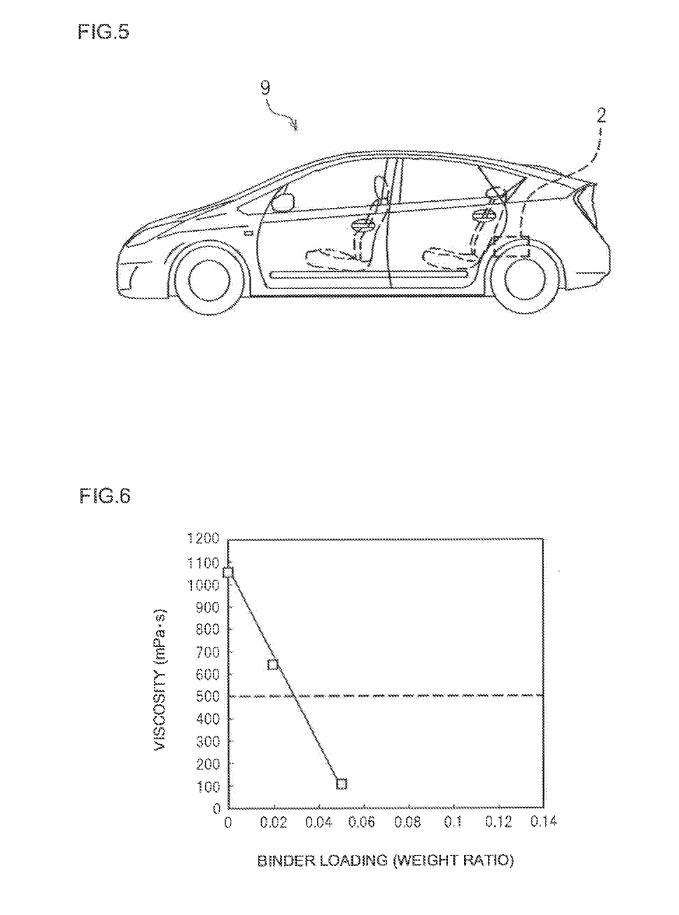

One conceivable method for adjusting the coating viscosity is to adjust the amount of hinder. The inventor conducted an experiment to determine the degree to which the coating viscosity changes with the amount of hinder. The insulating particles, the binder and the solvent used were, respectively, polyethylene particles having an average particle size of 3 μm, an ionomer resin and water. The experimental results are shown in FIG. 6. The horizontal axis in FIG. 6 represents the weight ratio of the binder with respect to the insulating particles. From FIG. 6, it is inferred that when the amount of hinder is 3 parts by weight or less per 100 parts by weight of the insulating particles, the coating viscosity becomes 500 mPa·s or more.

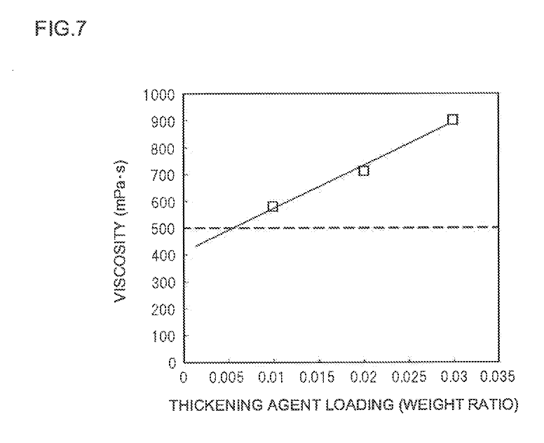

Another conceivable method for adjusting the viscosity of the coating is to add a thickening agent. The inventor conducted an experiment to determine the degree to which the coating viscosity changes with the amount of thickening agent. The insulating particles, the binder and the solvent used were, respectively, polyethylene particles having an average particle size of 3 μm, sodium polyactylate and water. The experimental results are shown in FIG. 7. The horizontal axis in FIG. 7 represents the weight ratio of the thickening agent with respect to the insulating particles. From FIG. 7, it is inferred that when the amount of thickening agent is 0.5 parts by weight or more per 100 parts by weight of the insulating particles, the coating viscosity becomes 500 mPa·s or more.

### Example 1

Using polyethylene particles having an average particle size of 3 μm as the insulating particles, a coating in the form of a paste was prepared by mixing together these insulating particles, an ionomer resin as the binder, and water as the solvent. The compounding ratio was set to 3 parts by weight of the binder per 100 parts by weight of the insulating particles. The viscosity of the coating was measured and found to be 600 mPa·s. As a result, it was confirmed that, at 3 parts by weight or less of binder per 100 parts by weight of insulating particles, the coating viscosity can be maintained at 500 mPa·s or more without the addition of a thickening agent.

### Example 2

A coating in the form of a paste was prepared by mixing together polyethylene particles having an average particle size of 3 μm (insulating particles), an ionomer resin as the binder, water as the solvent, and sodium polyacrylate as a thickening agent. The compounding ratios were set to 3 parts by weight of the binder and 0.5 parts by weight of the thickening agent per 100 parts by weight of the insulating particles. The viscosity of the coating was measured and found to be 1,148 mPa·s. On comparing these results with those from Example 1, it was confirmed that the viscosity of the coating rises as the amount of thickening agent is increased.

### Example 3

Aside from setting the compounding ratios to 3 parts by weight of binder and 1 part by weight of thickening agent per 100 parts by weight of the insulating particles, a coating was prepared in the same way as in Example 2. The viscosity of the coating was measured and found to be 2,230 mPa·s. On comparing these results with those from Examples 1 and 2, it was confirmed that the viscosity of the coating rises as the amount of thickening agent is increased.

### Reference Example 1

A coating was prepared in which thickening agent was added but the amount of binder was set to zero, and the viscosity of the coating was measured. That is, a coating in the form of a paste was prepared by mixing together polyethylene particles having an average particle size of 3 μm (insulating particles), water as the solvent and sodium polyacrylate as the thickening agent. Binder was not included in this coating. The compounding ratio was set to 0.5 parts by weight of the thickening agent per 100 parts by weight of the insulating particles. The viscosity of the coating was measured and found to be 636 mPa·s. It is apparent from these results and the results in Example 1 that when the amount of binder is not more than 3 parts by weight and the amount of thickening agent is at least 0.5 parts by weight per 100 parts by weight of the insulating particles, the viscosity of the coating can be more reliably set to at least 500 mPa·s.

### Reference Example 2

Aside from setting the amount of binder to 5 parts by weight and the amount of thickening agent to 1 part by weight per 100 parts by weight of the insulating particles, a coating was prepared in the same way as in Example 2. The viscosity of the coating was measured and found to be 446 mPa·s. It is apparent from these results that when the amount of binder is 5 parts by weight or more per 100 parts by weight of the insulating particles, even if the amount of thickening agent added is set to 1 part by weight, the viscosity of the coating ends up below 500 mPa·s. It is apparent from these results and the results in Example 1 that when the amount of binder is made too high, it is difficult to set the coating viscosity to 500 mPa·s or more by merely adding some thickening agent.

The results from Examples 1 to 3 and Reference Examples 1 and 2 indicate that, by at least setting the amount of binder to not more than 3 parts by weight and/or the amount of thickening agent to at least 0.5 parts by weight per 100 parts by weight of the insulating particles, the viscosity of the coating can be set to 500 mPa·s or more.

From the standpoint of increasing the smoothness of the separator layer, it is preferable for the coating to have a larger viscosity. On the other hand, from the standpoint of minimizing the variation in the amount of the applied coating and stabilizing the coating application step, it is preferable that the coating viscosity not be too large. Judging from the inventor's own experience, at a coating viscosity in excess of 5,000 mPa·s, the paste fluidity is poor, as a result of which paste retention tends to arise within the coating applicator. Such paste retention in turn causes a variation in the amount of the applied coating, leading to instability in the coating step. For this reason, the viscosity of the coating is preferably not more than 5,000 mPa·s.

### Example 4

Aside from setting the compounding ratio of binder to 5 parts by weight and the compounding ratio of thickening agent to 6 parts by weight per 100 parts by weight of the insulating particles, a coating was prepared in the same way as in Example 2. The coating viscosity was measured and found to be 894 mPa·s.

### Example 5

Aside from setting the compounding ratio of binder to 5 parts by weight and the compounding ratio of thickening agent to 12 parts by weight per 100 parts by weight of the insulating particles, a coating was prepared in the same way as in Example 2. The coating viscosity was measured and found to be 1,302 mPa·s.

### Example 6

Aside from setting the compounding ratio of binder to 5 parts by weight and the compounding ratio of thickening agent to 22 parts by weight per 100 parts by weight of the insulating particles, a coating was prepared in the same way as in Example 2. The coating viscosity was measured and found to be 1,916 mPa·s.

### Example 7

Aside from setting the compounding ratio of binder to 5 parts by weight and the compounding ratio of thickening agent to 44 parts by weight per 100 parts by weight of the insulating particles, a coating was prepared in the same way as in Example 2. The coating viscosity was measured and found to be 3,650 mPa·s.

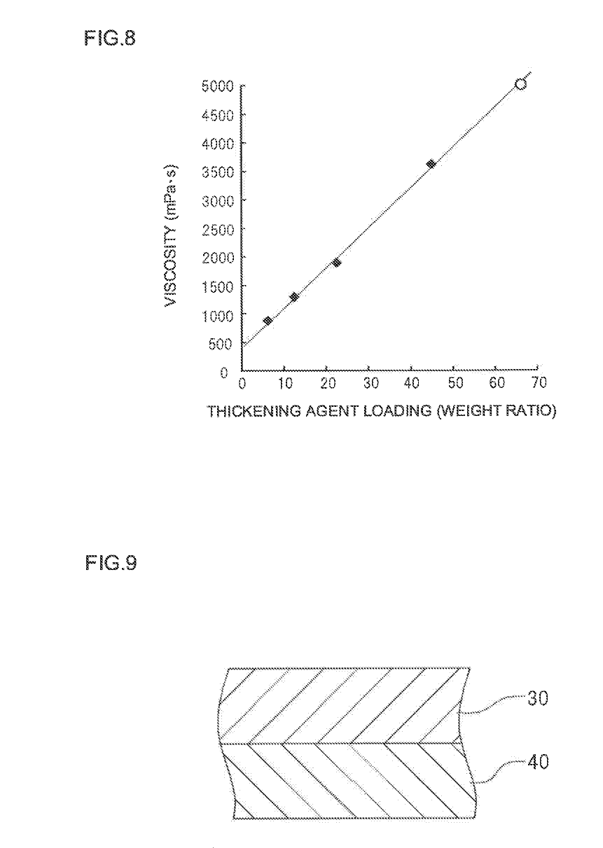

FIG. 8 is a graph showing the results for Examples 4 to 7. From the results for Examples 4 to 7, it can be inferred that when the amount of thickening agent included per 100 parts by weight of the insulating particles is 65 parts by weight or less, the viscosity of the coating becomes 5,000 mPa·s or less.

However, formation of the separator layer occurs with drying of the coating that has been applied to the surface of the electrode active material layer. The weight ratios of the binder and the thickening agent in the separator layer after such drying differ from the respective weight ratios of the binder and the thickening agent in the coating. The inventor formed a separator layer with a coating that contains no thickening agent, and measured the weight ratio of the insulating particles and the binder present in the separator layer after drying. At a compounding ratio of 3 parts by weight of binder per 100 parts by weight of the insulating particles, the weight ratio among solids in the separator layer was as follows: insulating particles:binder=40:0.81. In this case, the solids ratio of the binder was 2%. Therefore, when a separator layer was formed with a coating containing 3 parts by weight or less of binder per 100 parts by weight of insulating particles, the mass ratio of binder within the separator layer becomes 2% or less.

The inventor formed a separator layer with a coating that contains no binder, and measured the weight ratio of the insulating particles and the thickening agent present in the separator layer after drying. At a compounding ratio of 0.5 parts by weight of thickening agent per 100 parts by weight of the insulating particles, the weight ratio among solids was as follows: insulating particles:thickening agent=40:0.1. In this case, the thickening agent accounted for 0.2% of the solids. At a compounding ratio of 65 parts by weight of thickening agent per 100 parts by weight of the insulating particles, the weight ratio among solids was as follows: insulating particles:thickening agent=40:11.7. Here, the thickening agent accounted for 22.6% of the solids. Hence, in cases where a separator layer was formed with a coating that contains from 0.5 parts by weight to 65 parts by weight of thickening agent per 100 parts by weight of insulating particles, the mass ratio of thickening agent in the separator layer becomes from 0.2% to 22.6%.

Air Permeability of Separator Layer

The inventor carried out an experiment to determine the relationship between the porosity and air permeability of the separator layer. Using insulating particles having different average particle sizes, separator layers 30 of Sample 1 to Sample 3 were formed on the surface of a polyethylene film 40 having a thickness of 10 μm (see FIG. 9). Air was passed through the separator layer 30 and the polyethylene film 40, the length of time for the passage of 100 mL of air was measured, and this time was defined as the air permeability. The smaller the air permeability, the more easily air passes through and the higher the ionic permeability. The results are shown in Table 1.

TABLE 1

| | Average | | Film | Air |
|---|---|---|---|---|
| | particle | Porosity | thickness | permeability |
| | size (μm) | (%) | (μm) | (sec) |
| Sample 1 | 0.928 | 12.5 | 10 | 448 |
| Sample 2 | 3.199 | 38.2 | 13 | 399 |
| Sample 3 | 3.008 | 35.1 | 13 | 404 |

Air was passed through a polyethylene film having a thickness of 20 μm. The length of time required for the passage of 100 mL of air was measured and found to be 400 seconds. The air permeability of the Sample 1 was 448 seconds, which was about 10% higher than the air permeability of the polyethylene film. Therefore, Sample 1 was found to have a low ionic permeability compared with a polyethylene film alone. On the other hand, the air permeability of Sample 2 was 399 seconds and the air permeability of Sample 3 was 404 seconds; both had the same level of air permeability as a polyethylene film. Therefore, Sample 2 and Sample 3 were found to have ionic permeabilities similar to that of a polyethylene film. Hence, Sample 2 and Sample 3 exhibit ionic permeabilities similar to that of a conventional separator made of polyethylene film. In Sample 1, the porosity was 12.5%, which was relatively small. By contrast in Sample 2 and Sample 3, the porosity was at least 35%. It is apparent from these results that if the separator layer has a porosity of at least 35%, it exhibits an ionic permeability which is comparable to or greater than that of a conventional separator.

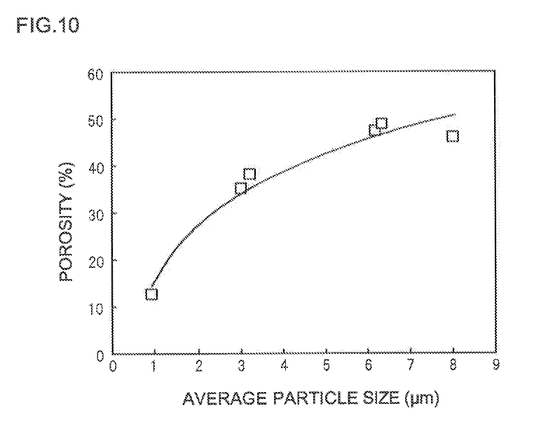

In addition, other insulating particles haying different average particle sizes were used, and the porosities of the resulting separator layers were measured. The results are shown in Table 2 and FIG. 10. From FIG. 10, it is apparent that as the average particle size of the insulating particles becomes larger, the porosity increases. At an average particle size of 3 μm or more, the porosity is at least 35%.

TABLE 2

| | Average | |
|---|---|---|
| | particle | Porosity |
| | size (μm) | (%) |
| Sample 1 | 0.928 | 12.5 |
| Sample 2 | 3.199 | 38.2 |
| Sample 3 | 3.008 | 35.1 |
| Sample 4 | 6.155 | 47.4 |
| Sample 5 | 7.979 | 46.0 |
| Sample 6 | 6.307 | 48.8 |

The invention has been described in detail above, but it should be noted that the foregoing embodiments and examples serve only to illustrate the invention. Various modifications and changes to the foregoing examples are encompassed by the invention as disclosed herein.

1.-6. (canceled)

7. A method for producing a battery, comprising the steps of:
providing a positive electrode which includes a positive electrode current collector and a positive electrode active material layer that contains a positive electrode active material and is formed on the positive electrode current conductor;
providing a negative electrode which includes a negative electrode current collector and a negative electrode active material layer that contains a negative electrode active material and is formed on the negative electrode current conductor;
preparing a separator layer-forming coating having a viscosity of from 500 mPa·s to 5,000 mPa·s by mixing together at least insulating particles, a binder, a thickening agent and a solvent; and
forming a separator layer having electrically insulating properties and porosity by applying the coating to a surface of at least one of the positive electrode active material layer and the negative electrode active material layer, and drying the applied coating.

8. A production method according to claim 7, which comprises, in the coating preparation step, adding from 0.5 parts by weight to 65 parts by weight of a thickening agent per 100 parts by weight of the insulating particles.

9. A production method according to claim 7, wherein the binder is included in the coating preparation step in an amount of not more than 3 parts by weight per 100 parts by weight of the insulating particles.

10. A production method according to claim 7, wherein in the coating preparation step, the binder is included in an amount of not more than 3 parts by weight per 100 parts by weight of the insulating particles, and from 0.5 parts by weight to 65 parts by weight of a thickening agent per 100 parts by weight of the insulating particles is added.

11. A production method according to claim 7, wherein polyacrylate is used as the thickening agent.

12. A battery comprising:
a positive electrode which includes a positive electrode current collector and a positive electrode active material layer that contains a positive electrode active material and is formed on the positive electrode current conductor;
a negative electrode which includes a negative electrode current collector and a negative electrode active material layer that contains a negative electrode active material and is formed on the negative electrode current conductor; and
a separator layer having electrically insulating properties and porosity, including insulating particles, a binder and a thickening agent, and formed on a surface of at least one of the positive electrode active material layer and the negative electrode active material layer,
wherein the binder has a mass ratio of not more than 2% with respect to the separator layer, and
the thickening agent has a mass ratio of from 0.2% to 22.6% with respect to the separator layer.

13. A battery according to claim 12, wherein the insulating particles have an average particle size of at least 3 μm and the separator layer has a porosity of at least 35%.
